(19) United States
(12) Patent Application Publication
(10) Pub. No.: US 2016/0265340 A1
(43) Pub. Date: Sep. 15, 2016

(54) CEMENTING JOB EVALUATION SYSTEMS AND METHODS FOR USE WITH NOVEL CEMENT COMPOSITIONS INCLUDING RESIN CEMENT

(71) Applicant: HALLIBURTON ENERGY SERVICES, INC., Houston, TX (US)

(72) Inventors: Gary J. Frisch, Houston, TX (US); Jones J. Paul, Humble, TX (US); Ivo Foianini, Humble, TX (US)

(73) Assignee: HALLIBURTON ENERGY SERVICES, INC., Houston, TX (US)

(21) Appl. No.: 14/650,533

(22) PCT Filed: Dec. 28, 2013
(86) PCT No.: PCT/US2013/078148

§ 371 Date: Jun. 8, 2015

(51) Int. Cl. E21B 47/00; G01V 1/46; E21B 33/14

(52) U.S. Cl. CPC E21B 47/0005; E21B 33/14; G01V 1/46; E21B 47/01

(57) ABSTRACT

Acoustic measurements are obtained and combined with some identification of regions that are expected or believed to be cemented. Based at least in part on this information, a processing unit derives an annular material classifier that can identify those measurements characteristic of the cemented regions (including regions cemented with a resin cement formulation), and that further applies the classifier to the measurements to generate a cement log that can be displayed to a user. Cross-plots of waveform amplitude, acoustic impedance, and the derivative of acoustic impedance, have revealed that resin cement, for example, has characteristic acoustic properties that form a small cluster within the range of expected measurements. For improved identification reliability, such clusters can be identified adaptively.

### BACKGROUND

When drilling, completing, or otherwise operating on a well, it is often necessary to determine if the material in the annular space between the formation and casing, and/or the annular space between multiple casing strings is filled with cement, fluids, mud and/or solid materials. For example, when cementing to provide zonal isolation, cement is injected by any one of various methods into the annular space to displace the material in the annular space with cement that solidifies and forms a permanent barrier. The original fluids in the annular space can include gas, water, drilling mud, hydrocarbons, formation fluids, formation solids, and any type of combination of above. Before completing and initiating production from a cemented well, it is standard practice to convey a suite of logging tools through the casing to determine the efficiency with which the annular fluids have been displaced and the consequent effectiveness of the zonal isolation.

As another example of characterizing annular materials, operators often wish to determine if the pipe or casing is still bonded to the formation after the economic life of the well is finished. Where the casing has detached from the cement, it may be possible to cut the casing above the attachment points and remove the casing from the well. A suite of logging tools may be run to determine the portions of casing that are free. From the data recorded from these cement evaluation tools both the original cement sheath, and the remaining cement sheath can be evaluated by scientific principles that are well known and available.

Several logging tools have been developed in the past to help determine the material behind pipe including sonic and ultrasonic tools, and they are often run together to evaluate the cementing job. Sonic tools measure the attenuation and speed of sonic waveforms propagating along the casing. Ultrasonic tools measure the reflections of ultrasonic pulses directed through the casing. Taken individually or together, these tools enable the measurement of, inter alia, the acoustic impedance of the annular material, which is defined as Z=ρV, where V is the speed of sound in the material and ρ is the density of the material.

However, drilling technology has evolved. New compositions of cement and drilling fluid have been developed such that the acoustic impedances of these materials are no longer sufficient to distinguish them apart. For example, the acoustic impedance of light (foam) cement overlap with the acoustic impedance values of water and light drilling mud. Conversely, heavy drilling muds have been developed with acoustic impedance values that overlap characteristic impedance values of conventional cement. Service providers continue seeking better techniques for reliably distinguishing between different types of annular materials.

### BRIEF DESCRIPTION OF THE DRAWINGS

Accordingly, there are disclosed in the drawings and the following description various cementing job evaluation systems and methods that are suitable for use with novel cement compositions including resin cement. In the drawings:

FIG. 1 shows an illustrative drilling environment.

FIG. 2 shows an illustrative cement bond logging environment.

FIG. 3 is a function block diagram of an illustrative cement evaluation system.

FIG. 4 is a multi-track log including measurements for cement evaluation.

FIGS. 5A-5D are cross-plots of sonic amplitude, acoustic impedance, and the impedance derivative.

FIG. 6 is a flow diagram of an illustrative cement evaluation method.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

In many cases, modern cement compositions have acoustic measurement properties that fall within the range of other annular materials, making it a challenge to provide predefined rules for distinguishing cemented regions. Accordingly, at least some disclosed cement evaluation system embodiments obtain acoustic measurements and combine them with some identification of regions that are expected or believed to be cemented. Based at least in part on this information, a processing unit derives an annular material classifier that can identify those measurements characteristic of the cemented regions, and that further applies the classifier to the measurements to generate a cement log that can be displayed to a user. The processing unit may obtain the acoustic measurements from a cement bond logging tool and/or from an ultrasonic scanning tool that provides a map of impedance measurements. Cross-plots of waveform amplitude, acoustic impedance, and the derivative of acoustic impedance, have revealed that resin cement, for example, has characteristic acoustic properties that form a small cluster within the range of expected measurements. For improved identification reliability, such clusters can be identified adaptively.

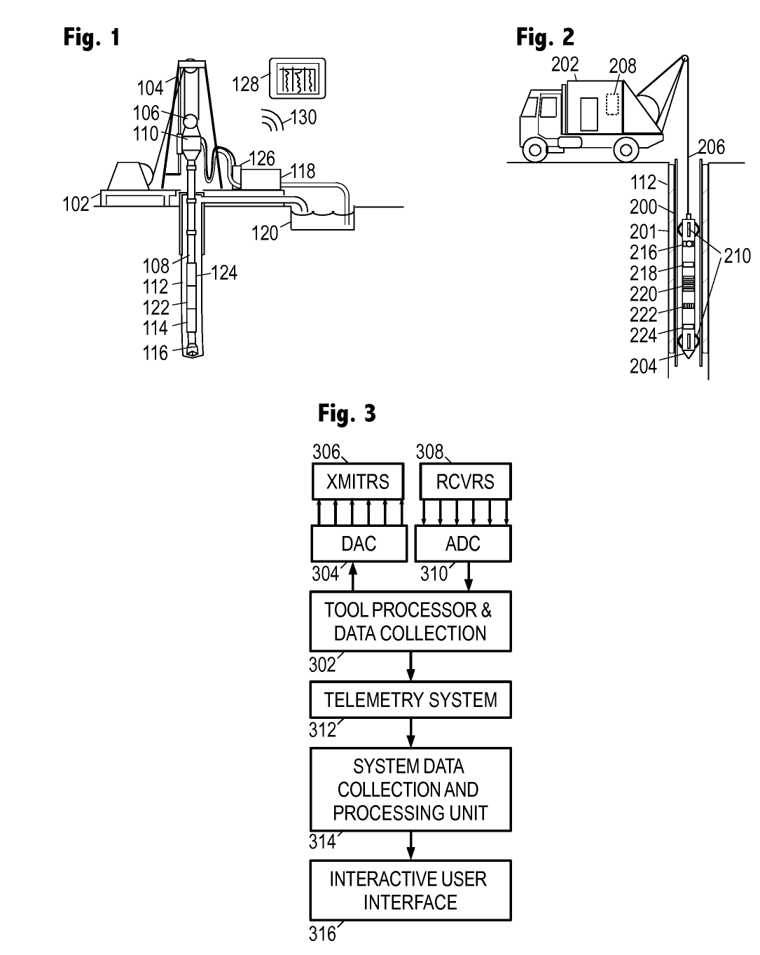

The disclosed systems and methods are best understood in their intended usage context. Accordingly, FIG. 1 shows an illustrative drilling environment. A drilling platform 102 supports a derrick 104 having a traveling block 106 for raising and lowering a drill string 108. A top drive 110 supports and rotates the drill string 108 as it is lowered into a borehole 112. The rotating drill string 108 and/or a downhole motor assembly 114 rotates a drill bit 116. As bit 116 rotates, it extends the borehole 112 through various subsurface formations. A pump 118 circulates drilling fluid through a feed pipe to the top drive assembly, downhole through the interior of drill string 108, through orifices in drill bit 116, back to the surface via the annulus around drill string 108, and into a retention pit 120. The drilling fluid transports cuttings from the borehole into the pit 120 and aids in maintaining the borehole integrity.

The drill bit 116 and motor assembly 114 form just one portion of a bottom-hole assembly that includes one or more drill collars (thick-walled steel pipe) to provide weight and rigidity to aid the drilling process. Some of these drill collars include built-in logging instruments to gather measurements of various drilling parameters such as position, orientation, weight-on-bit, borehole diameter, etc. The tool orientation may be specified in terms of a tool face angle (rotational orientation or azimuth), an inclination angle (the slope), and compass direction, each of which can be derived from measurements by magnetometers, inclinometers, and/or accelerometers, though other sensor types such as gyroscopes may alternatively be used. In one specific embodiment, the tool includes a 3-axis fluxgate magnetometer and a 3-axis accelerometer. As is known in the art, the combination of those two sensor systems enables the measurement of the tool face angle, inclination angle, and compass direction. Such orientation measurements can be combined with gyroscopic or inertial measurements to accurately track tool position.

Among the tools 122 integrated into the bottom-hole assembly may be an ultrasonic scanning tool and/or a sonic logging tool. As the bit extends the borehole through the subsurface formations, or as the drill string is tripped from the borehole, the logging tools 122 collect measurements of acoustic properties such as acoustic impedance, sonic wave speeds, and waveforms, which a downhole controller associates with tool position and orientation measurements. Though generally applied to collect formation property measurements in the open hole, such tools may also be employed (with appropriate adjustments to the transmitted signals) in the cased portion of the borehole to collect measurements for characterizing the material in the annulus. The measurements can be stored in internal memory and/or communicated to the surface. A telemetry sub 124 may be included in the bottom-hole assembly to maintain a communications link with the surface. Mud pulse telemetry is one common telemetry technique for transferring tool measurements to a surface interface 126 and to receive commands from the surface interface, but other telemetry techniques can also be used.

A processing unit, shown in FIG. 1 in the form of a tablet computer 128, communicates with surface interface 126 via a wired or wireless network communications link 130, and provides a graphical user interface (GUI) or other form of interface that enables a user to provide commands and to receive and optionally interact with a visual representation of the acquired measurements. The measurements may be in log form, e.g., a graph or image of the measurement value as a function of position along the borehole. The processing unit can take alternative forms, including a desktop computer, a laptop computer, an embedded processor, a cloud computer, a central processing center accessible via the internet, and any combination of the foregoing, with software that can be stored in memory for execution by the processor. The software, which can be supplied on a non-transient information storage medium, configures the processing unit to interact with the user to obtain, process and display the cementing evaluation information as provided in greater detail below.

As sections of the borehole are completed, the drill string 108 may be removed from the borehole 112 and replaced by a casing string 202 as shown in FIG. 2. A cement slurry is pumped into the annular space between the casing string 202 and the wall of the borehole 112 and it hardens to form a cement sheath 201. Ideally, the cement slurry displaces the drilling fluid and other materials from the annulus to form a continuous sheath that binds to the formation and tubing to seal the annulus against fluid flow. Various cement slurry compositions have been developed to provide various desirable features such as a density that can be tailored to avoid damage to the formation, a viscosity that is low enough to facilitate pumping and high enough to minimize mixing with other fluids, an ability to bind to the formation and casing material, and in some instances, a “self-healing” ability to seal any cracks that develop. Certain cement resin formulations offer an extremely adjustable set of properties.

Once the cementing job has been completed (i.e., the slurry has been pumped into position and allowed to set), the crew typically employs a wireline logging suite to evaluate the sheath and verify that the desired placement and sheath quality have been achieved. In other words, the cement crew verifies that the previous materials have been displaced in the regions where formation fluid inflows might otherwise occur and that there are no bubbles, gaps, or flow paths along the sheath. A logging truck 202 suspends a wireline logging sonde 204 on a wireline cable 206 having conductors for transporting power to the sonde and telemetry from the sonde to the surface.

On the surface, a computer 208 acquires and stores measurement data from the logging tools in the sonde 204 as a function of position along the borehole and as a function of azimuth. The illustrated sonde 204 includes an ultrasonic scanning tool 216 and a cement bond logging (CBL) tool having an omnidirectional source 218, an acoustic isolator 220, an azimuthally-sensitive receiver 222, and an omnidirectional receiver 224. Centralizers 210 keep the sonde centered as it is pulled uphole. The wireline sonde further includes an orientation module and a control/telemetry module for coordinating the operations of the various tools and communications between the various instruments and the surface.

The ultrasonic scanning tool 216 has a rotating transceiver head that transmits ultrasonic pulses and receives reflected pulses to and from many points on the inner circumference of the casing. The amplitudes of the initial reflection from the inner surface of the casing and subsequent reflections from the outer surface of the casing and acoustic interfaces beyond the casing are indicative of the acoustic impedances of the casing and the annular materials beyond the casing. The acoustic interfaces can be mapped by tracking the travel time of each reflection.

The CBL tool uses the acoustic source 218 to generate acoustic pulses that propagate along the casing string. The acoustic isolator 220 suppresses propagation of acoustic signals through the sonde itself. The receivers 222 and 224 detect the waveforms of the propagating acoustic signals, which have characteristics indicative of the quality of the cement sheath. For example, the maximum amplitude of the waveforms relative to the transmitted pulse varies with the quality of the bond between the casing and the cement.

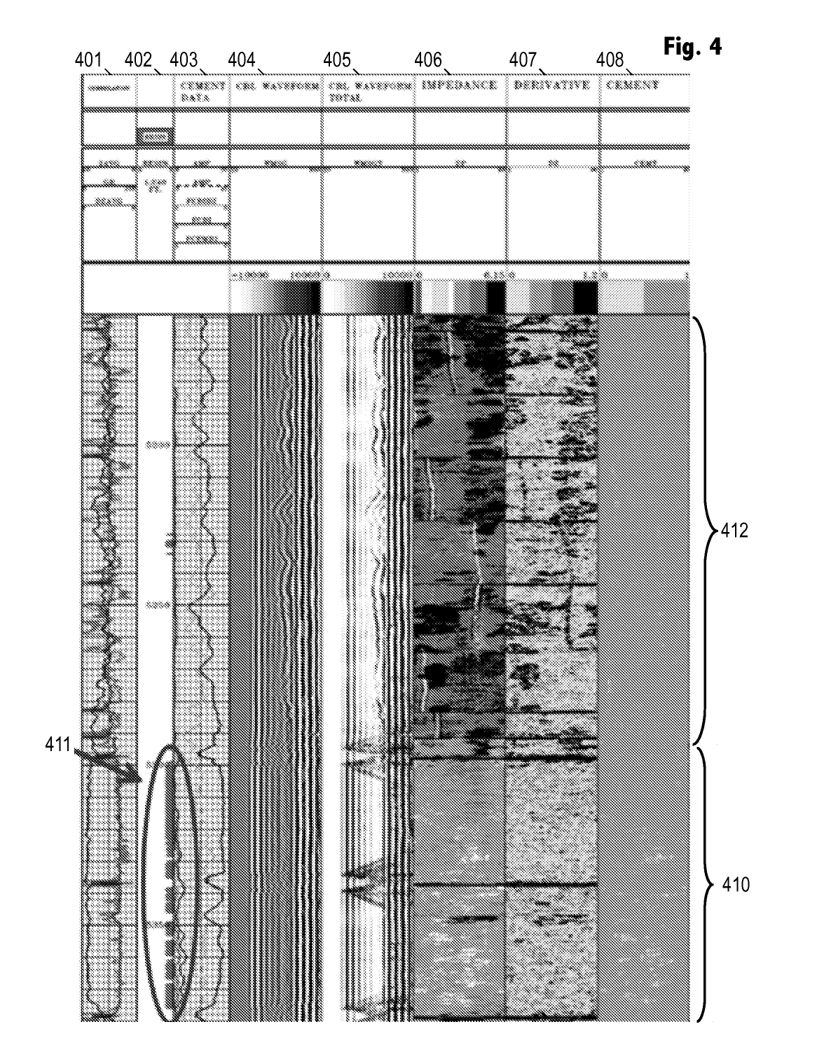

FIG. 3 is a function block diagram of an illustrative cement job evaluation system. An embedded downhole controller 302 provides transmit signal waveforms to a digital-to-analog converter 304 that drives the sonic tool source and/or the ultrasonic tool transmitter 306. Receive transducers 308 provide acoustic waveform signals to a digital to analog converter 310. The embedded controller 302 stores and optionally processes the digitized measurements, e.g., to obtain waveform amplitude, acoustic impedance, and derivative of acoustic impedance. Measurements from multiple closely-spaced positions may be combined to improve signal to noise ratio. The processed and/or unprocessed measurements are communicated to the surface by a telemetry system 312, which in some cases is a communications link established with the tool memory after the tool has been retrieved to the surface. In other implementations, the telemetry system 312 operates over a wireline cable or a mud-pulse telemetry channel.

A processing unit 314 on the surface collects and processes the measurement data in combination with information from other sources (e.g., a report of the regions that are to be, or are believed to have been, cemented) to provide a cementing log. As previously discussed, the surface processing unit may take the form of a computer in a wireline truck or mounted on a logging skid to collect the measurement data. The computer collects and processes the data in accordance with its installed software to derive the cement log from the tool measurements as a function of position along the borehole. A user interface 316 enables a user to view and optionally interact with a visual representation of the logs, e.g., by adjusting the track order, position, size, scale, and color. The logs may be displayed and updated as the data is collected. In some systems, the driller views the logs and other available operations data and uses them to sign off on properly cemented wells or to initiate corrective action for imperfect cementing results. Completions engineers may analyze the logs and other available survey data to construct a completion plan.

FIG. 4 shows an illustrative log having multiple tracks showing measurements suitable for evaluating a cement job and the results of that evaluation. Each of the tracks show the depth dependence of the measurements along the vertical axis, with tracks 404-405 further showing a time dependence along the horizontal axis and tracks 406-408 showing azimuthal dependence along the horizontal axis. In tracks 404-408, the pixel color is used to indicate the measurement value, with the scales being given at the top of the corresponding track. The horizontal scale is also provided at the top of each track and it may vary for each measurement.

Track 401 (“Correlation”) shows the average impedance on a scale from 10 to 0, the normalized gamma ray intensity on a scale from 0 to 100, and the average spatial derivative of impedance on a scale from 1 to 0. Track 402 shows depth labels in feet indicating that the displayed log spans the region from 5160 to 5380, and further shows a resin flag on a scale from 5 to 0. (The resin flag is binary valued, having a value of 1 where the measurements indicate resin is present and 0 where they do not.) Track 403 (“Cement data”) shows waveform amplitude (i.e., the peak of the acoustic waveform) on a scale from 0 to 70, and in amplified form on a scale from 0 to 10, and further shows a cement bond index derived from the raw impedance data (FCBI), and a cement bond index derived from the combined impedance and derivative data (FCEMBI).

Track 404 (“CBL waveform”) shows the received acoustic waveform as a function of time from 25 to 350 msec, which aids in identifying and tracking reflective interfaces. Track 405 (“CBL waveform total”) is a weighted sum of the received acoustic waveform with a spatial derivative of the received acoustic waveform, which emphasizes changes in the waveform such as the V-patterns created by the box-and-pin connections of the casing string. Track 406 (“Impedance”) shows the impedance image across the 90 bins that correspond to the full circumference of the borehole. Track 407 (“Derivative”) shows an image of the spatial derivative of the impedance with respect to depth, though other derivatives or variance measurements may be used. Track 408 (“Cement”) shows a cement log image across the borehole circumference, using binary values derived from the other measurements. A “1” indicates that an adequate cement sheath has been provided, while a “0” indicates a deficiency in the cement sheath. Region 410 is that region having a sufficient density of cement resin flags 411 to indicate that the sheath material is a cement resin, while the absence of such flags in region 412 indicates another annular material (in this case, a conventional cement sheath). The ensuing discussion illustrates techniques for generating such resin flags. (One caveat here is that the following discussion focuses on identifying the annular material and does not attempt to evaluate bonding between the annular material and the formation or bonding between the annular material and casing. The presumption is that with resin cements, such bonding may be less of a concern.)

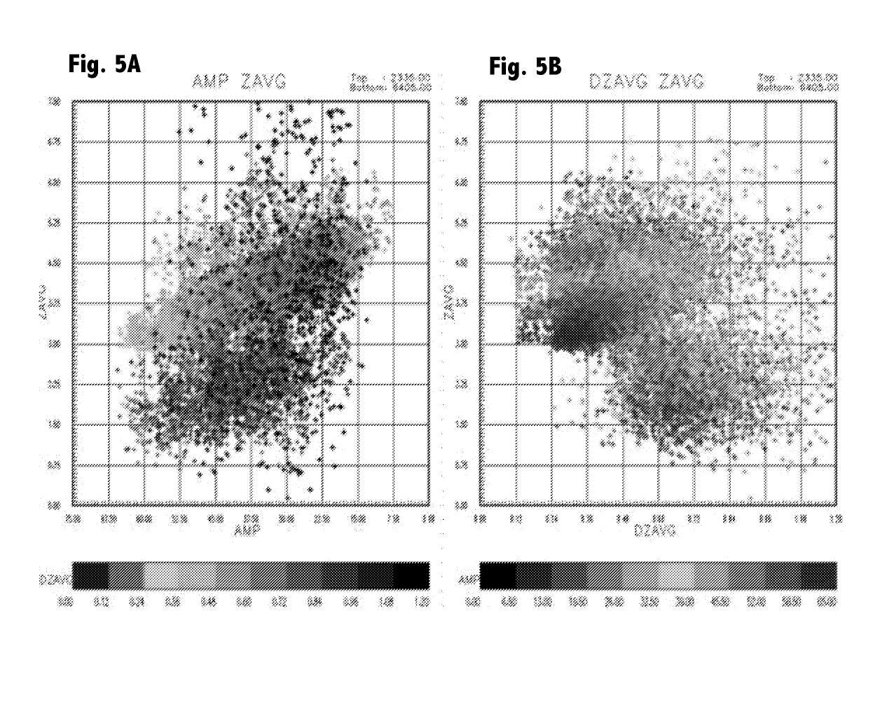

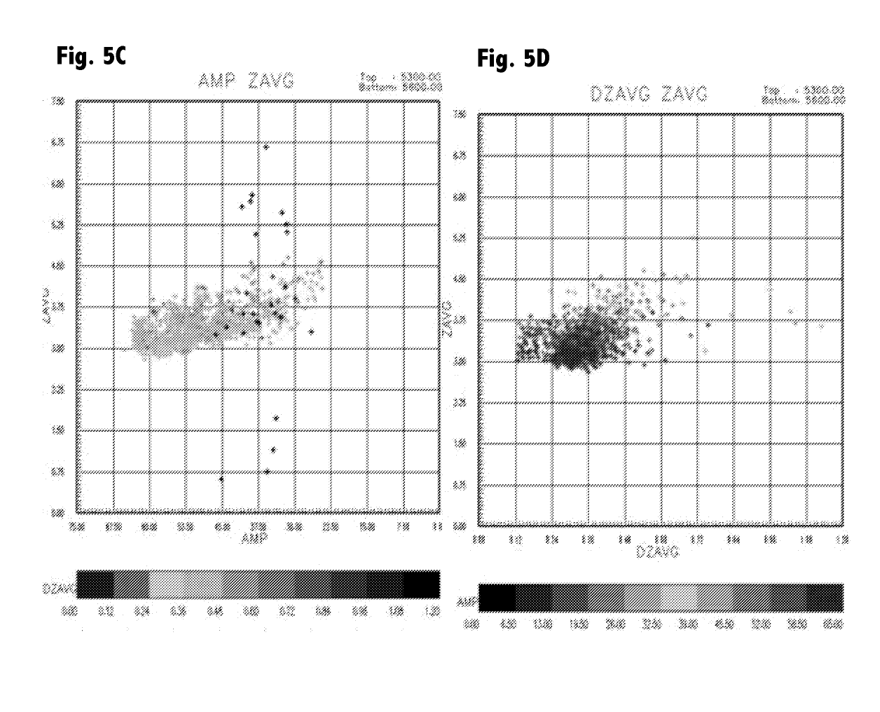

FIG. 5A shows a cross-plot of waveform amplitude (pixel color) versus average acoustic impedance (vertical axis) and average derivative of acoustic impedance (horizontal axis). FIG. 5B shows the derivative (color) versus impedance (vertical axis) and amplitude (horizontal axis). The measurements from the entire logging interval are shown. Compare these cross-plots with the same cross-plots (FIGS. 5C and 5D) for just the measurements from the interval expected to have only resin cement. It can be seen that in these cross-plots, the measurements characteristic of resin cement are contained within a small area of the overall measurement distribution. That is, the measurements in the resin cemented region have a fairly consistent waveform amplitude, average impedance, and derivative. Due to the varying nature of the cementing environment and resin cement formulations, the identification of this cluster may need to be performed dynamically.

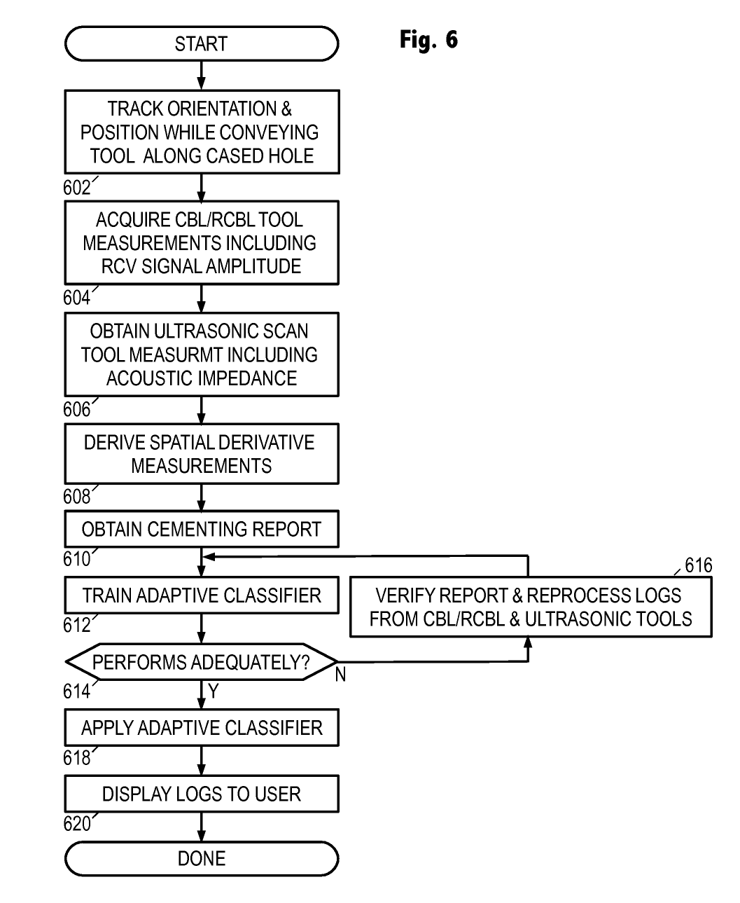

FIG. 6 is a flowchart of an illustrative cement evaluation method that may be implemented by the systems disclosed above. In block 602, the suite of logging tools is conveyed along a borehole while its position and orientation are tracked. For LWD, the tool is part of the bottom hole assembly and is used to perform logging while tripping. For wireline logging, the tool is part of a sonde that is lowered to the bottom of the region of interest and configured to perform logging as the logging tool is pulled uphole at a steady rate.

To perform logging, the cement bond logging tool's acoustic transmitter(s) are pulsed and the corresponding responses of each of the receivers are measured in block 604. The responses are the acoustic waveforms that have propagated along the casing to the receiver, from which a peak waveform amplitude can be derived. In block 606, the ultrasonic scanning tool's transceiver sends short pulses toward different points around the inner circumference of the casing and records the responses, which are the waveforms reflected from acoustic interfaces in that region. From such measurements, acoustic impedance can be derived.

In block 608, the processing unit derives the spatial derivative of acoustic impedance, with the sign removed by squaring or taking the absolute value. This derivative serves as an indication of the “texture” of the annular material, with mixed materials and aggregates such as conventional cement exhibiting a relatively high derivative and gases or simple fluids exhibiting a relatively low derivative.

In block 610, the processing unit obtains and processes a cementing report to determine the likely annular materials for one or more regions within the logging region. The logging report may be a specification of the desired or planned result of the cementing job, or it may be an estimated result provided by a manual analysis of the tool logs. At least one region is specified as having a resin cement in the annular space.

In block 612, the processing unit employs the specification of intervals to derive a measurement-based classifier of the annular materials. Thus, for example, the processing unit examines the interval specified as having resin cement and identifies characteristic measurements. Such an identification can be performed adaptively using, for example, neural networks or other automated learning systems, clustering techniques, linear programming, or even trial-and-error delineations between putatively characteristic and non-characteristic measurements. In each case, a representative measurement or portion of the measurement space is identified as being characteristic of the resin cement or other annular material.

In block 614, the processing unit determines whether the classifier provides adequate performance. A number of testing techniques could be employed for this determination. For example, the system may test whether the percentage of measurement locations classified as resin cement within the specified region(s) exceeds a predetermined threshold and whether the percentage of measurement locations classified as resin cement outside the specified regions falls below a second predetermined threshold.

If the classifier fails to achieve adequate performance, the system in block 616 may request verification of the specified regions and/or may reprocess the tool logs to, e.g., achieve a higher signal to noise ratio at the expense of spatial resolution. The system may further adjust the classifier's training parameters and/or the type of classifier, before repeating the training in block 612.

Once adequate performance has been achieved, the system in block 618 applies the classifier to all the measurements from the logging interval to generate a cement log. The classifier may operate by determining whether the measurements fall within a bounded measurement area, or whether the similarity between the measurements and a characteristic measurement exceeds a predetermined threshold. In some embodiments, the cement log is an image or map of the annular space with pixel color or intensity that indicates the type of annular material, with one of the colors indicating the presence of resin cement. In a binary implementation, the pixel color may indicate the presence or absence of cement at each point in the annular space. In other embodiments, the cement log is a graph indicating the percentage of the annular space occupied by cement. Some of the foregoing embodiments may be accompanied by flags on a separate track to indicate the cement type, e.g., whether the measurements are characteristic of a resin cement or not. In block 620, the system stores the cement log and makes it available for use by analysts, e.g., by displaying the log on a monitor or other form of user interface.

Numerous variations and modifications will become apparent to those skilled in the art once the above disclosure is fully appreciated. It is intended that the following claims be interpreted to embrace all such variations and modifications where applicable.

What is claimed is:

1. A cement evaluation system that comprises:
one or more logging tools that collect acoustic measurements while being conveyed through a logging region of a casing string in a cemented well; and
a processing unit that obtains said measurements and receives an indication of cemented regions within the logging region, said cemented regions being cemented with a resin cement, wherein the processing unit combines said measurements with said indication to derive a classifier for annular material around the casing, wherein the processing unit applies the classifier to the measurements to generate a cement log that is displayed to a user.

2. The system of claim 1, wherein the one or more logging tools include:
a cement bond logging tool that provides waveform amplitude measurements of acoustic energy propagating along the casing; and
a scanning ultrasonic logging tool that provides acoustic impedance measurements,
wherein the acoustic measurements obtained by the processing unit include said waveform amplitude measurements, said acoustic impedance measurements, and a spatial derivative of the acoustic impedance measurements.

3. The system of claim 2, wherein the classifier identifies as cemented those regions having waveform amplitude, acoustic impedance, and acoustic impedance derivative within a range characteristic of resin cement, said range being determined by said processing.

4. The system of claim 3, wherein the cement log comprises flags for those regions where the classifier identifies the annular material as a resin cement.

5. The system of claim 3, wherein the cement log comprises an image having pixel color or intensity indicative of an annular material type.

6. The system of claim 3, wherein the cement log comprises a curve indicative of a percentage or volume of annular material that is resin cement.

7. The system of claim 3, wherein as part of said combining, the processing unit compares one or more measurement cross-plots for the cemented regions to one or more measurement cross-plots having measurements outside the cemented regions and determines a classification boundary that delineates resin-cemented region measurements from measurements for other regions.

8. The system of claim 1, wherein as part of said combining, the processing unit trains an adaptive classifier to distinguish cemented regions from other regions based on said measurements.

9. The system of claim 8, wherein the adaptive classifier comprises a neural network.

10. The system of claim 1, wherein as part of said combining the processing unit employs an adaptive clustering technique to determine a representative measurement vector for cemented regions, and wherein the classifier operates by comparing measurements to the representative measurement vector.

11. A cement evaluation method that comprises:
obtaining measurements from one or more logging tools conveyed through a logging region of a casing string in a cemented well;
specifying one or more cemented regions within the logging region;
combining the measurements with the specification of cemented regions to derive a classifier for annular material around the casing;
generating a cement log for the logging region by applying the classifier to said measurements; and
displaying the cement log.

12. The method of claim 11, wherein the measurements include sonic waveform amplitude, acoustic impedance, and a spatial derivative of acoustic impedance.

13. The method of claim 12, wherein the classifier identifies as cemented those regions having waveform amplitude, acoustic impedance, and acoustic impedance derivative within a range characteristic of resin cement, said range being determined by said processing.

14. The method of claim 13, wherein the cement log comprises flags for those regions where the classifier identifies the annular material as a resin cement.

15. The method of claim 13, wherein the cement log comprises an image having pixel color or intensity indicative of an annular material type.

16. The method of claim 13, wherein the cement log comprises a curve indicative of a percentage or volume of annular material that is resin cement.

17. The method of claim 13, wherein said combining includes:
comparing one or more measurement cross-plots for the cemented regions to one or more measurement cross-plots having measurements outside the cemented regions; and
determining a classification boundary that delineates resin-cemented region measurements from measurements for other regions.

18. The method of claim 11, wherein said combining includes training an adaptive classifier to distinguish cemented regions from other regions based on said measurements.

19. The method of claim 18, wherein the adaptive classifier comprises a neural network.

20. The method of claim 11, wherein said combining includes employing an adaptive clustering technique to determine a representative measurement vector for cemented regions, and wherein the classifier operates by comparing measurements to the representative measurement vector.

21. A non-transient information storage medium that, when placed in operable relation to a computer, causes the computer to execute a cement evaluation process having operations that include:
obtaining measurements from one or more logging tools conveyed through a logging region of a casing string in a cemented well;
specifying one or more cemented regions within the logging region;
combining the measurements with the specification of cemented regions to derive a classifier for annular material around the casing;
generating a cement log for the logging region by applying the classifier to said measurements; and
displaying the cement log.

22. The medium of claim 21, wherein said combining includes training an adaptive classifier to distinguish cemented regions from other regions based on said measurements.

23. The medium of claim 22, wherein the adaptive classifier comprises a neural network.

24. The medium of claim 21, wherein said combining includes employing an adaptive clustering technique to determine a representative measurement vector for cemented regions, and wherein the classifier operates by comparing measurements to the representative measurement vector.
